(19) United States
(12) Patent Application Publication
(10) Pub. No.: US 2017/0354178 A1
(43) Pub. Date: Dec. 14, 2017

(54) COMPOSITION CONTAINING CHITIN AND DIGESTIBLE PROTEINS

(71) Applicant: YNSECT, Evry Cedex (FR)

(72) Inventors: Benjamin Armenjon, Paris (FR); Nathalie Berezina, Paris (FR); Sophie Laurent, Paris (FR); Antoine Hubert, Alfortville (FR); Cecilia Socolsky, Paris (FR); Lorena Sanchez, Evry (FR)

(73) Assignee: YNSECT, Evry Cedex (FR)

(21) Appl. No.: 15/541,149

(22) PCT Filed: Dec. 30, 2015
(86) PCT No.: PCT/FR2015/053784

§ 371 Date: Jun. 30, 2017

(30) Foreign Application Priority Data
Dec. 31, 2014 (FR) 1463512
Oct. 20, 2015 (FR) 1560013

(51) Int. Cl. A23L 33/17; A23K 20/147; A21D 13/04

(52) U.S. Cl. CPC A23L 33/17; A21D 13/04; A23K 20/147; A23V 2002/00

(57) ABSTRACT

The present invention relates to a composition containing at least 67% by weight crude proteins, at least 5% by weight chitin, the weight percentages relating to the total weight of the composition, and 85% by weight digestible protein relative to the total weight of crude protein. The invention is also directed to a method for preparing the composition and to the uses thereof, in particular in human or animal nutrition.

The present invention relates to a composition comprising proteins and chitin. It also relates to a method for the preparation of this composition and use thereof in human or animal nutrition, and more particularly in fish feed.

Aquaculture is now one of the most dynamic sectors in the food industry. The high demand for fish has resulted in a significant increase in the price of feed intended for farming fish.

One of the most used products in fish feed is fishmeal. In fact, fishmeal is one of the main sources of proteins in aquaculture feeds. It is a meal that is very rich in animal proteins (rich in amino acids of the lysine and methionine types) that are easy to digest. A growing demand accompanied by a limited supply has resulted in a significant increase in its price, creating a risk to the sustainable growth of aquaculture. Thus, there is a high demand for alternative sources of high-quality and, so far as possible, renewable proteins for aquaculture feeds.

Insect meals offer natural replacement protein sources and the possibility of being mass-produced with a minimal ecological footprint. In particular, certain insects such as Tenebrio molitor, have the benefit of being suitable for intensive mass production.

However, the results of tests substituting various insect meals for fishmeal prove to be mixed. In the case where substitution proves possible, it generally does not exceed 50%, effects detrimental to the growth of the fish being observed beyond this content.

The inventors' work has made it possible to demonstrate that a specific composition could be advantageously used to replace a fishmeal in aquaculture feed.

The present invention therefore relates to a composition comprising at least 67% by weight crude proteins, at least 5% by weight chitin, the percentages by weight being given relative to the total weight of composition, and 85% by weight digestible proteins relative to the total weight of crude proteins.

It will be noted that in the context of the present application, and unless otherwise stipulated, the ranges of values indicated are understood to be inclusive.

The quantification of “crude proteins” is well known to a person skilled in the art. By way of example, the Dumas method or the Kjeldahl method may be mentioned. Preferably, the Dumas method, corresponding to the standard NF EN ISO 16634-1 (2008), is used.

Throughout the application, when no date is specified for a regulation, a standard or a directive, it refers to the regulation, standard or directive in force on the filing date.

Preferably, the composition comprises 68% by weight crude proteins, more preferably 70% by weight crude proteins, the percentages by weight being given relative to the total weight of composition.

By “digestible proteins”, is meant the digestible proteins determined by pepsin digestibility. The quantification of the digestible proteins will preferably be carried out by the method described in Directive 72/199/EC.

Preferably, the composition comprises 86%, more preferably 88% by weight digestible proteins relative to the total weight of crude proteins.

According to the invention, by “chitin”, is meant any type of chitin derivative, i.e. any type of polysaccharide derivative comprising N-acetyl-glucosamine units and D-glucosamine units, in particular the chitin-polypeptide copolymers (sometimes referred to as “chitin-polypeptide composite”). These copolymers can also be combined with pigments, often of the melanin type.

Chitin would be the second most synthesized polymer in the living world after cellulose. In fact, chitin is synthesized by numerous species of the living world: it constitutes part of the exoskeleton of crustaceans and insects and the lateral wall which surrounds and protects fungi. More particularly, in insects, chitin thus constitutes 3 to 60% of their exoskeleton.

The chitin content is determined by extraction thereof. Such a method can be the method AOAC 991.43 described in Example 2, and is a preferred method for this determination.

Preferably, the composition comprises between 5 and 16% by weight chitin, more preferably between 8 and 14% chitin, the percentages by weight being given relative to the total weight of composition.

The compositions of the prior art capable of containing both proteins and chitin are generally compositions obtained from insects and/or crustaceans. However, the high crude protein and digestible protein contents in the composition according to the invention can be obtained only by an insect- and/or crustacean-processing method, comprising a hydrolysis step. A hydrolysis step has the effect of reducing the chitin content to a level of the order of 5% by weight, such as less than 5% by weight, relative to the total weight of the composition.

Now, chitin is often considered as a kind of anti-nutritional factor because it is difficult to digest. This explains why for applications in the agri-food sector, insect-based compositions are dechitinized, i.e. a step of removing the chitin is carried out. The inventors' work also made it possible to demonstrate that, contrary to received ideas, chitin had no impact on the growth of fish fed with a composition according to the invention, comprising a significant chitin content (see Example 4 below). On the contrary, the composition according to the invention can advantageously replace not only part but also all of a fishmeal in an aquaculture feed. In fact, the composition according to the invention makes it possible to improve the growth of animals fed with this composition.

Moreover, during the feed-manufacturing process, the introduction of the composition according to the invention also has certain advantages: reducing losses of water-soluble vitamins during optional heat treatments and reducing the energy required during an optional extrusion step.

Preferably, the composition according to the invention has a residual moisture content comprised between 2 and 15%, preferably between 5 and 10%, more preferably, between 6 and 8%. This moisture content can, for example, be determined according to the method originating from EC Regulation 152/2009 of 27 Jan. 2009 (103° C./4 h).

Advantageously, the composition according to the invention has an ash content less than or equal to 4% by weight relative to the total weight of composition, and even more advantageously, less than or equal to 3.5%.

Ash constitutes the residue resulting from the combustion of the composition according to the invention.

The method for determining the ash content is well known to a person skilled in the art. Preferably, the ash content was determined according to the method laid down by EC regulation 152/2009 of 27 Jan. 2009.

The fat content of the composition according to the invention is preferably comprised between 5 and 20% by weight relative to the total weight of composition, more preferably between 9 and 17%.

The methods for determining the fat content are well known to a person skilled in the art. By way of example and in preferred manner, this content will be determined according to the method of EC regulation 152/2009.

As indicated above, the composition according to the invention can be obtained from insects.

By “obtained” from insects, is meant more particularly a composition obtained solely from insects and optionally water. The composition results from a mechanical, heat treatment to the exclusion of any chemical treatment (other than by water) of the insects.

More particularly, the composition is an insect meal. By “insect meal”, is meant a powder having a particle size acceptable for human or animal nutrition. By “particle size acceptable for human or animal nutrition”, is meant a particle size comprised between 100 μm and 1.5 mm, preferably comprised between 300 μm and 1 mm, more preferably between 500 and 800 μm.

The insects preferred for the preparation of such a meal are for example beetles (Coleoptera), diptera, lepidoptera, isoptera, orthoptera, hymenoptera, blattoptera, hemiptera, heteroptera, ephemeroptera and mecoptera, preferably beetles, diptera, orthoptera, lepidoptera or mixtures thereof.

Preferably, the insects are selected from the group constituted by Tenebrio molitor, Hermetia illucens, Galleria mellonella, Aiphitobius diaperinus, Zophobas morio, Blattera fusca, Tribolium castaneum, Rhynchophorus ferrugineus, Musca domestica, Chrysomya megacephala, Locusta migratoria, Schistocerca gregaria, Acheta domesticus, Samia ricini or mixtures thereof, and even more preferably, Tenebrio molitor.

Advantageously, the composition according to the invention comprises between 35 and 65% by weight soluble proteins relative to the total weight of crude proteins, and at least 50% of the soluble proteins have a size less than or equal to 12,400 g/mol.

By “soluble proteins”, is meant, among the crude proteins, those which are soluble in an aqueous solution the pH of which is comprised between 6 and 8, advantageously between 7.2 and 7.6.

Preferably, the aqueous solution is a buffer solution the pH of which is comprised between 6 and 8, advantageously between 7.2 and 7.6. Preferably, the buffer solution is an NaCl phosphate buffer solution, the pH of which is equal to 7.4+/−0.2.

The digestibility of proteins in humans and animals is very much determined by the size of the proteins. In animal nutrition, it is common to reduce the size of the proteins in order to facilitate digestion by the animals. This reduction in the size of the proteins is generally carried out by hydrolysis processes (for example enzymatic), the implementation of which is particularly costly.

The composition according to the invention, obtained by a process not involving hydrolysis, comprises a large quantity of soluble proteins the size of which is sufficiently reduced to facilitate digestion by animals. The composition according to the invention also has the advantage of being able to be prepared at a lower cost.

Advantageously, the composition according to the invention comprises between 30 and 60% by weight, preferably between 35 and 55% by weight soluble proteins relative to the total weight of crude proteins.

Preferably, at least 60%, preferably at least 70% of the soluble proteins have a size less than or equal to 12,400 g/mol.

More particularly, the soluble proteins have a size comprised between 6,500 and 12,400 g/mol.

Advantageously, less than 10%, preferably less than 8%, more preferably less than 5%, and even more preferably 0% of the soluble proteins have a size greater than or equal to 66,000 g/mol.

Such a distribution of the soluble proteins is demonstrated in Example 6.

The invention also discloses a method for the preparation of a composition according to the invention.

The method for the preparation of a composition according to the invention comprises a step of pressing insects.

The objective of the pressing is to de-oil the insects and thus to obtain a press cake having an oil (or fat) content less than or equal to 20% by weight relative to the dry weight of press cake, preferably less than or equal to 17%.

The pressing step is described more fully in step 2 of the preparation method detailed hereafter.

In particular, it is possible to carry out hot or cold pressing. Preferably, a single-screw press is used.

More particularly, the preparation method according to the invention comprises the following steps:
i) killing the insects,
ii) pressing the insects in order to obtain a press cake, and
iii) grinding the press cake.

The insects can be killed by scalding or blanching, as described more fully hereafter in step 1 of the detailed method.

Similarly, the grinding is described more fully in step 4 of the detailed method.

Finally, the preparation method according to the invention can also comprise a step of drying the press cake.

The drying step is advantageously carried out after the pressing step and before the grinding step.

The drying is described more fully in step 3 of the method detailed.

Detailed Method for the Preparation of a Composition According to the Invention

Step 1: Killing the Insects

This killing step 1 can advantageously be carried out by scalding or by blanching. This step 1 makes it possible to kill the insects while reducing the microbial load (reducing the risk of deterioration and health risk) and by inactivating the internal enzymes of the insects which can trigger autolysis, and thus a rapid browning thereof.

For the scalding, the insects, preferably larvae, are thus scalded with water for 2 to 20 min, preferably 5 to 15 min. Preferably, the water is at a temperature comprised between 95 to 105° C., preferably 100° C.

The quantity of water introduced during the scalding is determined as follows: the ratio of the volume of water in mL to the weight in g of insect is preferably comprised between 0.3 and 10, more preferably between 0.5 and 5, even more preferably between 0.7 and 3, even more preferably of the order of 1.

For the blanching, the insects, preferably larvae, are blanched with steam (steam nozzles or bed) at a temperature comprised between 80 and 130° C., preferably between 90 and 120° C., more preferably between 95 and 105° C., preferably 98° C. or with water at a temperature comprised between 95 and 105° C., preferably 100° C. (by spray nozzles) or in mixed mode (water+steam) at a temperature comprised between 80 and 130° C., preferably between 90 and 120° C., more preferably between 95 and 105° C., preferably 98° C. The residence time in the blanching chamber is comprised between 1 and 15 minutes, preferably between 3 and 7 min.

(Optional) Step: Grinding

The insects are removed from the scalding tank or blanching chamber, they are then sieved (or drained), and placed in a grinder, such as a knife mill, making it possible to reduce the insects to particles.

In order to facilitate the grinding, a quantity of water can be added. This quantity of water is similar to that introduced during step 1 of scalding: the ratio of the volume of water in mL to the weight in g of insect is preferably comprised between 0.3 and 10, more preferably between 0.5 and 5, even more preferably between 0.7 and 3, even more preferably of the order of 1. It is also possible to keep the scalding water and/or the water resulting from the blanching in order to carry out this step.

Preferably, on completion of the grinding, the size of the insect particles is less than 1 cm (largest particle size observable using a microscope), preferably less than 0.5 cm. Preferably, the size of the particles is comprised between 300 μm and 3 mm, more preferably between 500 μm and 1 mm. It is not necessary to excessively reduce the size of the particles, for example to a size less than 250 μm.

Step 2: Pressing

The insects originating from step 1 of killing, or the wet paste originating from the optional grinding step is then placed in a press according to a procedure which makes it possible to press and separate a juice comprising both a fat fraction and a protein fraction.

Preferably, the pressing step makes it possible to obtain a press cake comprising an oil content less than or equal to 20% by weight relative to the dry weight of the press cake, preferably, less than or equal to 17%, more preferably less than or equal to 15%.

Similarly, the pressing step makes it possible to obtain a press cake having a dry matter content comprised between 30% and 60%, preferably comprised between 40% and 55%, and more preferably comprised between 45% and 55%.

Any press system can be used for carrying out the pressing step, such as for example a single-screw or twin-screw press (twin-screw press of the Angel type), a filter press (filter press of the Choquenet type), a platen press, etc. These systems are well known to a person skilled in the art who is able to determine the pressing conditions in order to obtain the oil and/or water contents mentioned above.

In particular, it is possible to carry out hot or cold pressing. Advantageously, the pressing will be carried out hot, which makes it possible to increase the de-oiling of the press cake. In particular, hot pressing makes it possible to obtain a press cake comprising an oil content less than or equal to 17% by weight relative to the dry weight of press cake, preferably less than or equal to 15%.

Step 3: Drying

The press cake is then dried by the standard technologies known to a person skilled in the art. The drying can be direct or indirect (thin layer dryer, “paddle dryer”, “tubular dryer”, “disc-dryer”, etc.) at a temperature comprised between 60° C. and 200° C., for a duration of 15 min to 24 hours. By way of example, the press cake can be arranged and dried in ventilated/stirred air at a temperature comprised between 80 and 100° C., preferably at 90° C. for a duration comprised between 3 and 7 hours, preferably 5 hours.

The objective of this drying step is to obtain a press cake having a moisture content comprised between 2 and 15%, preferably between 5 and 10%, even more preferably between 4 and 8%.

Step 4: Final Grinding

The dried press cake is then placed in a grinder, such as a hammer mill, making it possible to reduce the press cake to particles.

Advantageously, on completion of this final grinding, the size of the insect particles is less than 0.5 cm (largest particle size observable using a microscope), preferably of the order of 1 mm. More particularly, the particle size is comprised between 300 μm and 1 mm, even more preferably between 500 and 800 μm.

The succession of these four steps makes it possible to obtain a composition according to the invention, comprising a high level of crude proteins and digestible proteins while maintaining a chitin content of the order of at least 5% by weight relative to the total weight of the composition.

As indicated above, the pressing step can be carried out cold or hot.

By way of example of a method for obtaining a composition according to the invention, involving cold pressing:

Larvae, for example of T. molitor, are introduced into a beaker containing 200 mL of water brought to the boil beforehand, and killed by scalding in a water bath at 100° C. After 5 minutes, the beaker is removed from the water bath, the larvae are drained, then mixed with a volume of water of 200 mL. The liquid thus obtained is passed into a twin-screw-type press. The press cake thus obtained is dried for 24 hours in an oven at 70° C., then ground to 250 μm.

By way of example of a method for obtaining a composition according to the invention, involving hot pressing:

Larvae, for example of T. molitor, are introduced into a blanching chamber and blanched in steam for 5 min at 100° C. The larvae thus blanched are then introduced into a “drying”-type press suitable for water-laden products. The press cake thus obtained is dried for 5 hours in an oven at 90° C., then ground in a hammer mill to 1 mm.

Preferably, the method for the preparation of a composition according to the invention comprises the following steps:
i) killing the insects,
ii) pressing the insects in order to obtain a press cake,
iii) drying the press cake, and
iv) grinding the press cake.

According to a first embodiment of the method according to the invention, the pressing step is preceded by a step of grinding the insects.

The invention thus relates to a method for the preparation of a composition according to the invention comprising the following steps:
i) killing the insects,
ii) pressing the insects in order to obtain a press cake,
iii) drying the press cake, and
iv) grinding the press cake,
in which the pressing step is preceded by a step of grinding the insects.

An advantage of the step of grinding the insects prior to the pressing is described more fully in Example 5.

According to a second embodiment of the method according to the invention, the step of pressing the insects is carried out hot.

The invention thus relates to a method for the preparation of a composition according to the invention comprising the following steps:
i) killing the insects,
ii) pressing the insects in order to obtain a press cake,
iii) drying the press cake, and
iv) grinding the press cake,
in which the pressing step is carried out hot.

As indicated above, hot pressing makes it possible to obtain a press cake comprising an oil content less than or equal to 17% by weight relative to the dry weight of press cake, preferably less than or equal to 15%.

According to a third embodiment of the method according to the invention, the step of grinding the press cake is carried out to a particle size comprised between 300 μm and 1 mm, preferably between 500 and 800 μm.

The invention thus relates to a method for the preparation of a composition according to the invention comprising the following steps:
i) killing the insects,
ii) pressing the insects in order to obtain a press cake,
iii) drying the press cake, and
iv) grinding the press cake,
in which the step of grinding the press cake is carried out to a particle size comprised between 300 μm and 1 mm.

More particularly, in this third embodiment of the method according to the invention, the step of pressing the insects can be carried out hot. Alternatively, the pressing step can be preceded by a step of grinding the insects.

The invention finally relates to the use of a composition according to the invention in human or animal nutrition.

Advantageously, the composition according to the invention can be used in feed for pets such as dogs, cats, birds, fish, reptiles and rodents.

More particularly, the composition according to the invention can be used in aquaculture (fish, crustaceans, molluscs, shellfish), feed for poultry (chicken, turkey, game such as quail, pheasant, bustard), pigs, ruminants (cattle, sheep, goats, horses) and mink.

Finally, the composition according to the invention can be advantageously used to replace a protein flour.

By protein flour is meant more particularly a fishmeal, milk powder or lactoserum powder, concentrated soy protein (“CSP”), meat meal, such as for example poultry meal.

The replacement can be partial or total.

Preferably, the composition according to the invention is used for partial or total replacement of a fishmeal, such as a 50 or 100% replacement.

Other features and advantages of the invention will become apparent from the following examples, given by way of illustration, with reference to:

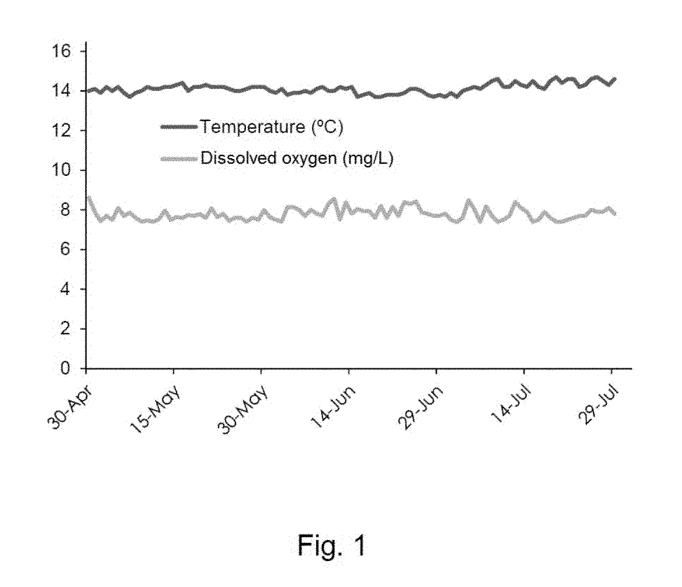

FIG. 1, which is a diagram illustrating the variations in temperatures of the water and in the levels of oxygen dissolved in the tanks where trout fed with different doses of composition according to the invention were farmed,

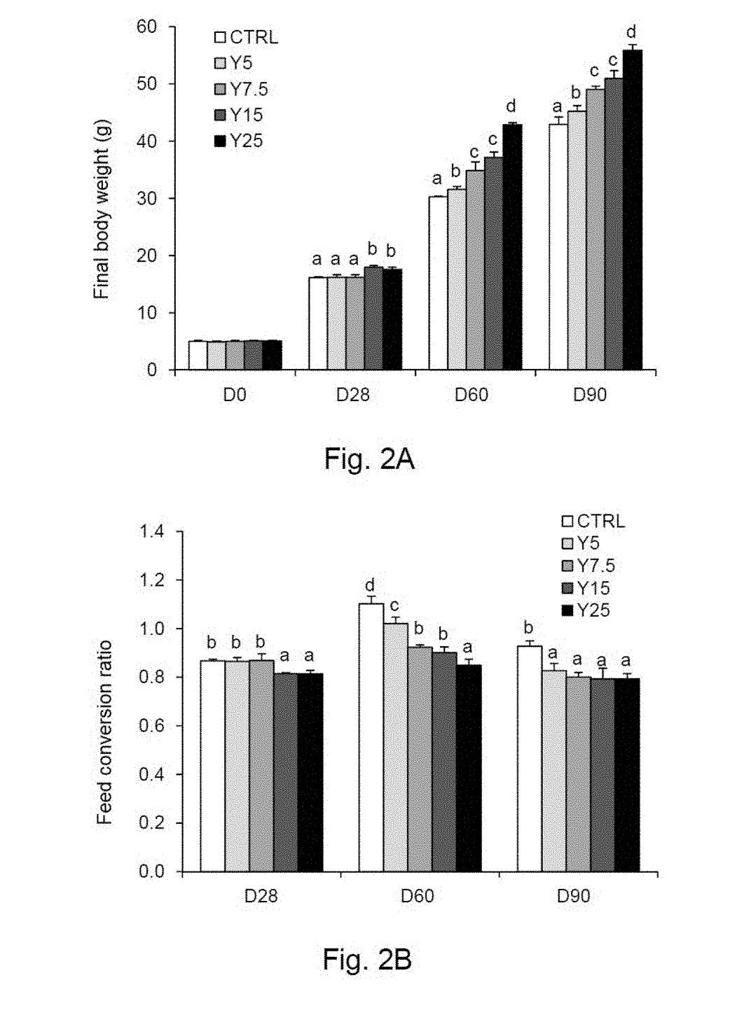

FIG. 2, which comprises two diagrams illustrating the impact on final body weight (FIG. 2A) and the feed conversion ratio (FIG. 2B) of trout fed with different doses of composition according to the invention,

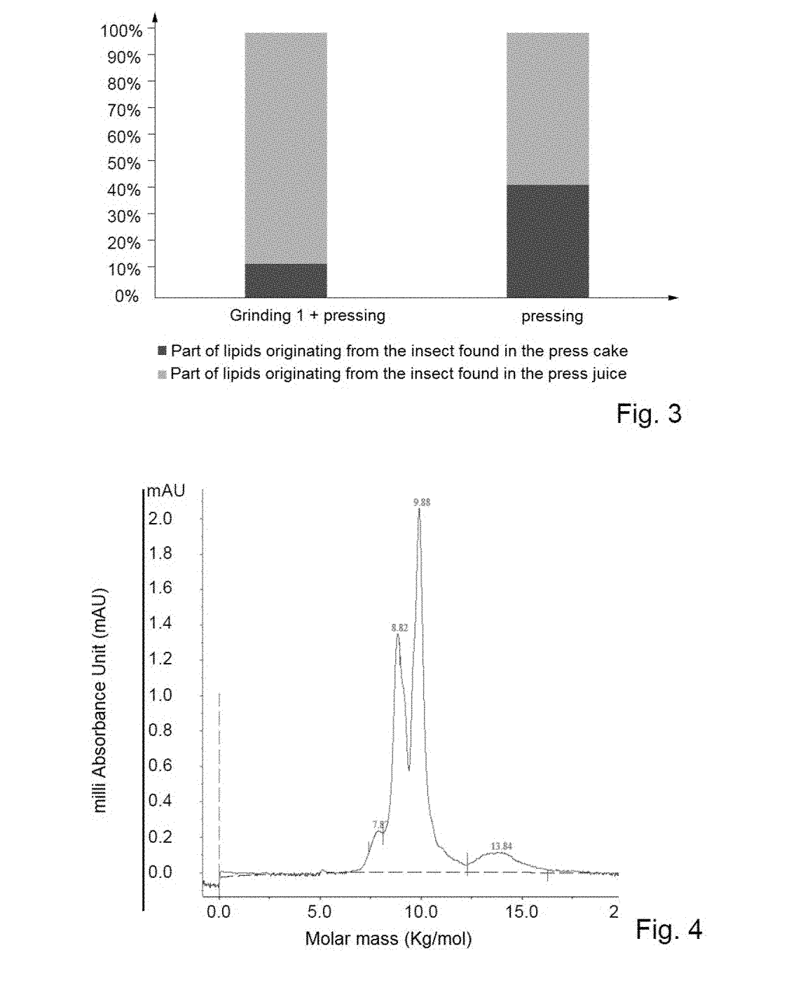

FIG. 3, which illustrates the distribution of the lipids originating from the insect found in the juice and the press cake obtained by a method comprising a pressing step or a grinding step then pressing, and

FIG. 4, which is a diagram representing steric exclusion chromatography analysis of the size of the proteins of the composition according to the invention.

### EXAMPLE 1: METHOD FOR THE PREPARATION OF A COMPOSITION ACCORDING TO THE INVENTION

The composition according to the invention is prepared from Tenebrio molitor larvae. Upon receipt of the larvae, they can be stored at 4° C. for 0 to 15 days in their rearing tanks without major degradation before being killed. The weight (age) of the larvae used is variable and as a result their composition can vary, as illustrated in Table 1 below:

TABLE 1
Biochemical composition of Tenebrio molitor
larvae according to their weight.

| Biomass (insects) | mg | 23 | 35 | 58 | 80 | 108 | 154 |
|---|---|---|---|---|---|---|---|
| Dry matter | %* | 34 | 34 | 34.2 | 37.9 | 39.6 | 39.5 |
| Ash | %* | 1.59 | 1.52 | 1.6 | 1.75 | 1.67 | 1.43 |
| Crude proteins | %* | 22.6 | 22.2 | 22 | 23.2 | 23.1 | 23.2 |
| Lipids | %* | 6.62 | 6.88 | 7.98 | 10.3 | 10.9 | 11.7 |

*The % are expressed as dry weight relative to the wet weight of larvae.

Step 1: Blanching of the Insects

Living larvae (+4° C. to +25° C.) are conveyed in layers with a thickness comprised between 2 and 10 cm, on a perforated conveyor belt (1 mm) to a blanching chamber. The insects are thus blanched in steam (steam nozzles or bed) at 98° C. or in water at 100° C. (spray nozzles) or in mixed mode (water+steam). The residence time in the blanching chamber is comprised between 1 to 15 minutes, ideally 5 min.

The temperature of the larvae after blanching is comprised between 75° C. and 98° C.

Step 2: Pressing

The larvae, once blanched, are conveyed to the feed hopper of a continuous single-screw press. While passing into the press, the larvae are maintained at a temperature above 70° C. in order to increase the de-oiling yields. The principle of de-oiling is to pressurize the material inside a cylindrical cage by means of an arrangement of screws and rings arranged on the central shaft. The cage is lined inside with bars distributed in sections and kept apart by spaces of different thicknesses depending on the work area. The interstices thus arranged allow the flow of an oil/fat fraction while limiting the passage of the so-called “dry” matter, the protein fraction, which is called “press cake”, thus being involved in the pressurization.

The pressing yields obtained are comprised between 48 and 55%.

Y_{cake}=(mass_{cake}/mass_{juice}+mass_{cake})

The press cake obtained contains 35 to 40% dry matter, 67 to 75% proteins and 13 to 17% fats, the percentages by weight being given relative to the dry weight of press cake.

Step 3: Drying

The press cake is then arranged on a tray in a thin layer (approximately 2 cm) and is dried in ventilated/stirred air at 90° C. for 5 hours in order to obtain a press cake having a dry matter content greater than 92%.

This step makes it possible to guard against any contamination having occurred since the killing.

The water activity (A_{W}) after drying is 0.35. The microbiological results show an absence of Salmonella spp (method: IRIS Salmonella BKR 23/07-10/11) and Enterobacteria values less than 10 CFU/g (method: NF ISO 2128-2, December 2004, 30° C. and 37° C.).

Step 4: Grinding

The dried press cake, comprising mainly proteins, is finally ground using a continuous hammer mill (6 reversible moving parts—thickness 8 mm). The grinder is fed by a hopper with a flow rate control flap (180 kg/h). The perforated grill used to control the output granulometry is 0.8 mm. The speed of rotation of the motor is 3,000 rpm (electric motorization, absorbed power 4 kW (5.5 CV)).

### EXAMPLE 2: CHARACTERIZATION OF THE COMPOSITION ACCORDING TO THE INVENTION

The composition prepared in Example 1 was characterized.

1. Analyses

1.1 Determination of the Moisture Content

The moisture content is determined according to the method originating from EC Regulation 152/2009 of 27 Jan. 2009 (103° C./4 h).

1.2 Determination of the Quantity of Crude Proteins

The crude proteins are determined according to the method called Dumas, and corresponding to the standard NF EN ISO 16634-1 (2008).

1.3 Determination of the Quantity of Chitin

The dietary fibres in the insect meal are essentially composed of chitin, the latter was therefore assayed according to the method AOAC 991.43. The values thus obtained are slightly overestimated as a result.

1.4 Determination of the Quantity of Fat

The fat was determined according to the method of EC Regulation 152/2009.

1.5 Determination of the Quantity of Ash

The crude ash was determined according to the method under EC Regulation 152/2009 of 27 Jan. 2009.

1.6 Determination of the Quantity of Phosphorus

The phosphorus is assayed by ICP (“induced coupled plasma”) with internal calibration.

1.7 Determination of Energy

The energy value is obtained with the coefficients of EU Regulation 1169/201.

1.8 Determination of the Quantities of Amino Acids and Fatty Acids

This determination was carried out by gas chromatography after hydrolysis and derivatization of the amino acids and fatty acids respectively.

1.9 Determination of Pepsin Digestibility

The pepsin digestibility is measured by the method described in Directive 72/199/EC.

2. Results

The composition according to the invention is detailed in Table 2 below.

TABLE 2
composition

| Macronutrient | Unit | Composition |
|---|---|---|
| Moisture | %* | 5.32 |
| Protein | %* | 67.09 |
| Chitin | %* | 8.0 |
| Fat | %* | 13.6 |
| Ash | %* | 3.21 |
| Total phosphorus | %* | 0.75 |
| Energy | MJ/kg | 23.74 |
| Amino acids | Unit | Composition |
| Arginine | %* | 2.56 |
| Histidine | %* | 1.39 |
| Isoleucine | %* | 2.11 |
| Leucine | %* | 3.99 |
| Lysine | %* | 3.32 |
| Threonine | %* | 1.87 |
| Valine | %* | 2.91 |
| Methionine | %* | 1.43 |
| Cysteine | %* | 0.63 |
| Fatty acids | Unit | Composition |
| C12:0 | %* | 0.03 |
| C14:0 | %* | 0.22 |
| C15:0 | %* | 0.01 |
| C16:0 | %* | 1.33 |
| C16:1 | %* | 0.05 |
| C16:1n-7 | %* | 0.16 |
| C17:0 | %* | 0.02 |
| C17:1 | %* | 0.01 |
| C18:0 | %* | 0.35 |
| C18:1n-9 | %* | 3.03 |
| C18:1n-7 | %* | 0.04 |
| C18:2n-6 | %* | 2.96 |
| C18:2tn-6 | %* | 0.02 |
| C18:3n-3 | %* | 0.14 |
| C20:0 | %* | 0.02 |
| C20:1n-9 | %* | 0.01 |
| C20:2n-6 | %* | 0.01 |
| C22:0 | %* | 0.01 |
| Phenylalanine | %* | 1.98 |
| Tyrosine | %* | 2.68 |
| Taurine | %* | 0.42 |
| Aspartic acid + | %* | 4.51 |
| asparagine | | |
| Glutamic acid + | %* | 6.36 |
| glutamine | | |
| Alanine | %* | 3.83 |
| Glycine | %* | 2.54 |
| Proline | %* | 3.18 |
| Serine | %* | 2.94 |

*The percentages by weight are expressed relative to the total weight of composition.

Moreover, a pepsin digestibility of 90+/−2% is obtained.

### EXAMPLE 3: ALTERNATIVE METHOD FOR THE PREPARATION OF A COMPOSITION ACCORDING TO THE INVENTION

200 g of T. molitor larvae are introduced into a beaker, placed in a water bath at 100° C. and containing 200 mL of water brought to the boil beforehand. After 5 minutes, the beaker is removed from the water bath, the larvae are drained, then mixed with a volume of water of 200 mL. The liquid thus obtained is passed into a press of the twin-screw type. The press cake thus obtained is dried for 24 hours in an oven at 70° C., then ground to 250 μm. A composition according to the invention is thus obtained.

### EXAMPLE 4: INTRODUCTION OF THE COMPOSITION ACCORDING TO THE INVENTION INTO FISH FEED

In the present example, the effect of including a composition according to the invention in feed on growth, feed intake, feed conversion, body composition and the apparent digestibility of the nutrients in the rainbow trout was studied.

### 1. Material and Methods

1.1. Composition According to the Invention

The composition utilized in this example is that obtained according to Example 1 and described more fully in Example 2.

1.2. Experimental Diets

A fishmeal-based diet (CTRL) was formulated with convenient ingredients in order to meet the known nutritional needs of juvenile rainbow trout. This CTRL diet is composed 25% of fishmeal, 8% of other protein sources of marine origin (squid meal and krill meal), while the remaining protein sources were a concentrate of soy protein, wheat gluten and maize gluten. On the basis of this formulation, four test diets (Y5, Y7.5, Y15 and Y25) were formulated, in which the fishmeal was replaced with the composition according to the invention in respective contents of 20, 30, 60 and 100% (see Table 3 below).

TABLE 3
Formulation and composition of the experimental diets.

| Ingredients | | | | | |
|---|---|---|---|---|---|
| in %*: | CTRL | Y5 | Y7.5 | Y15 | Y25 |
| Fishmeal | 25.00 | 20.00 | 17.50 | 10.00 | 0.00 |
| LT70¹ | | | | | |
| Krill meal² | 3.00 | 3.00 | 3.00 | 3.00 | 3.00 |
| Squid meal³ | 5.00 | 5.00 | 5.00 | 5.00 | 5.00 |
| Composition | | 5.00 | 750 | 15.00 | 25.00 |
| according | | | | | |
| to the | | | | | |
| invention | | | | | |
| Concentrate of | 14.00 | 14.00 | 14.00 | 14.00 | 14.00 |
| soy proteins⁴ | | | | | |
| Wheat gluten⁵ | 9.05 | 9.25 | 9.40 | 9.65 | 10.10 |
| Maize gluten⁶ | 8.20 | 8.20 | 8.20 | 8.20 | 8.20 |
| Soy meal 48 | 7.50 | 7.50 | 7.50 | 7.50 | 7.50 |
| Whole peas | 6.15 | 5.75 | 5.40 | 4.75 | 3.70 |
| Fish oil | 11.50 | 11.50 | 11.50 | 11.50 | 11.50 |
| Rapeseed oil | 6.00 | 5.80 | 5.70 | 5.40 | 5.00 |
| Pre-mixture | 1.50 | 1.50 | 1.50 | 1.50 | 1.50 |
| of vitamins | | | | | |
| and minerals⁷ | | | | | |
| Soy lecithin | 1.00 | 1.00 | 1.00 | 1.00 | 1.00 |
| Guar gum | 0.20 | 0.20 | 0.20 | 0.20 | 0.20 |
| Antioxidant | 0.20 | 0.20 | 0.20 | 0.20 | 0.20 |
| Sodium | 0.10 | 0.10 | 0.10 | 0.10 | 0.10 |
| propionate | | | | | |
| Monocalcium | 1.30 | 1.70 | 2.00 | 2.60 | 3.50 |
| phosphate | | | | | |
| DL-methionine | 0.30 | 0.30 | 0.30 | 0.40 | 0.50 |
| Yttrium oxide⁸ | 0.02 | 0.02 | 0.02 | 0.02 | 0.02 |
| Dry matter | 93.4 ± 0.0 | 93.1 ± 0.0 | 93, ± 0.1 | 95.0 ± 0.0 | 93.2 ± 0.0 |
| (DM), %* | | | | | |
| Crude protein, | 48.5 ± 0.0 | 48.5 ± 0.1 | 48.5 ± 0.0 | 48.5 ± 0.0 | 48.5 ± 0.1 |
| % DM** | | | | | |
| Crude fats, | 22.7 ± 0.2 | 22.7 ± 0.1 | 22.6 ± 0.2 | 22.7 ± 0.2 | 22.7 ± 0.2 |
| % DM** | | | | | |
| Ash, % DM** | 9.4 ± 0.0 | 8.8 ± 0.0 | 8.7 ± 0.1 | 8.1 ± 0.0 | 7.4 ± 0.0 |
| Chitin, | 0.06 | 0.46 | 0.66 | 1.26 | 2.06 |
| % DM** | | | | | |
| Gross energy, | 23.2 ± 0.2 | 23.2 ± 0.0 | 23.2 ± 0.0 | 23.2 ± 0.1 | 23.2 ± 0.1 |
| MJ/kg of | | | | | |
| DM | | | | | |

*% of dry matter relative to the total weight of the composition
**% by dry weight relative to the total weight of the dry matter
¹Peruvian fishmeal LT70: 71% crude proteins (CP), 11% crude fats (CF), EXALMAR, Peru;
²Krill meal: 61% CP, 19% CF, Aker BioMarine Antarctic AS, Norway;
³Super Prime without viscera: 82% CP, 3.5% CF, Sopropêche, France;
⁴Soycomil P: 62% CP, 0.7% CF, ADM, Netherlands;
⁵VITEN: 84.7% CP, 1.3% CF, ROQUETTE, France;
⁶Maize gluten meal: 61% CP, 6% CF, COPAM, Portugal;
⁷PREMIX Lda, Portugal. Vitamins (IU or mg/kg diet): DL-alpha tocopherol acetate, 100 mg; Menadione sodium bisulfite, 25 mg; Retinyl acetate, 20,000 IU; DL-cholecalciferol, 2000 IU; thiamine, 30 mg; riboflavin, 30 mg; pyridoxine, 20 mg; cyanocobalamine, 0.1 mg; nicotinic acid, 200 mg; folic acid, 15 mg; ascorbic acid, 1000 mg; inositol, 500 mg; biotin, 3 mg; calcium pantothenate, 100 mg; choline chloride, 1000 mg, betaine, 500 mg. Minerals (g or mg/kg): cobalt carbonate, 0.65 mg; copper sulphate, 9 mg; ferric sulphate, 6 mg; potassium iodide, 0.5 mg; manganese oxide, 9.6 mg; sodium selenite, 0.01 mg; zinc sulphate, 7.5 mg; sodium chloride, 400 mg; calcium carbonate, 1.86 g; excipient wheat;
⁸the yttrium oxide was incorporated in only a fraction of the feed used for the digestibility measurement.

The levels of squid and krill meal were kept constant among all the diets in order to guarantee a high palatability. Minor adjustments were made to the formulation of the diets tested in order to maintain the isonitrogenous conditions (crude protein, 48.5% DM), isolipidic conditions (22.7% DM) and isoenergetic conditions (crude energy, 23.2 MJ/kg DM). The levels of supplementation with methionine and monocalcium phosphate in the diets tested were adjusted in order to correspond to those found in the CTRL feed.

The diets were produced by extrusion (granule sizes: 1.2 and 2.0 mm) using a CLEXTRAL BC45 twin-screw extruder on a pilot scale with a screw diameter of 55.5 mm and a temperature range of 119 to 123° C. During the extrusion, all the batches of extruded feeds were dried in a vibrating fluidized bed dryer (model DR100, TGC Extrusion, France). After cooling the granules, the oils were added by coating under vacuum (model PG-10VCLAB, Dinnisen, Netherlands). Throughout the duration of the test, the experimental feeds were stored at ambient temperature, but in a cool, well-ventilated place. Samples representative of each diet were taken for analysis (Tables 4-5).

TABLE 4
Amino acid profile of the experimental diets.

| Amino | | | | | |
|---|---|---|---|---|---|
| acids | CTRL | Y5 | Y7.5 | Y15 | Y25 |
| Arginine | 4.62 ± 0.23 | 4.53 ± 0.02 | 4.49 ± 0.23 | 4.27 ± 0.09 | 3.89 ± 0.09 |
| Histidine | 1.47 ± 0.11 | 1.56 ± 0.02 | 1.54 ± 0.09 | 1.46 ± 0.07 | 1.50 ± 0.08 |
| Isoleucine | 2.31 ± 0.01 | 2.52 ± 0.01 | 2.53 ± 0.01 | 2.46 ± 0.02 | 2.49 ± 0.00 |
| Leucine | 4.51 ± 0.08 | 4.44 ± 0.01 | 4.68 ± 0.05 | 4.46 ± 0.02 | 4.56 ± 0.01 |
| Lysine | 3.09 ± 0.19 | 3.09 ± 0.01 | 3.02 ± 0.17 | 2.94 ± 0.01 | 2.97 ± 0.03 |
| Threonine | 2.32 ± 0.03 | 2.37 ± 0.00 | 2.31 ± 0.03 | 2.14 ± 0.05 | 2.15 ± 0.02 |
| Valine | 2.75 ± 0.00 | 2.87 ± 0.02 | 3.00 ± 0.03 | 3.08 ± 0.01 | 3.18 ± 0.01 |
| Methionine | 1.71 ± 0.15 | 1.71 ± 0.01 | 1.75 ± 0.06 | 1.74 ± 0.02 | 1.63 ± 0.02 |
| Cysteine | 0.35 ± 0.02 | 0.34 ± 0.00 | 0.31 ± 0.02 | 0.33 ± 0.00 | 0.34 ± 0.00 |
| Pheny- | 3.30 ± 0.00 | 3.06 ± 0.01 | 2.92 ± 0.15 | 2.85 ± 0.01 | 2.56 ± 0.00 |
| lalanine | | | | | |
| Tyrosine | 2.44 ± 0.11 | 2.48 ± 0.00 | 2.67 ± 0.14 | 2.92 ± 0.04 | 3.14 ± 0.12 |
| Taurine | 0.20 ± 0.01 | 0.20 ± 0.00 | 0.21 ± 0.01 | 0.06 ± 0.00 | 0.04 ± 0.00 |

The contents are indicated in percentages by weight relative to the total weight of granules before drying.

TABLE 5
Synthesis of the fatty acid profile of the experimental diets.

| Fatty acids | CTRL | Y5 | Y7.5 | Y15 | Y25 |
|---|---|---|---|---|---|
| C14:0 | 0.04 ± 0.00 | 0.04 ± 0.00 | 0.38 ± 0.00 | 0.43 ± 0.00 | 0.38 ± 0.00 |
| C16:0 | 1.86 ± 0.01 | 1.89 ± 0.01 | 1.82 ± 0.02 | 2.11 ± 0.01 | 1.94 ± 0.02 |
| C16:1n-7 | 0.48 ± 0.00 | 0.48 ± 0.00 | 0.44 ± 0.00 | 0.50 ± 0.00 | 0.42 ± 0.01 |
| C18:0 | 0.49 ± 0.00 | 0.50 ± 0.01 | 0.47 ± 0.01 | 0.54 ± 0.00 | 0.50 ± 0.01 |
| C18:1n-9 | 1.62 ± 0.01 | 1.74 ± 0.01 | 1.69 ± 0.01 | 2.08 ± 0.01 | 2.06 ± 0.02 |
| C18:1n-7 | 0.26 ± 0.00 | 0.25 ± 0.00 | 0.23 ± 0.00 | 0.25 ± 0.00 | 0.21 ± 0.00 |
| C18:2n-6 | 0.79 ± 0.00 | 0.94 ± 0.01 | 1.05 ± 0.01 | 1.36 ± 0.01 | 1.53 ± 0.02 |
| C18:3n-3 | 0.13 ± 0.00 | 0.13 ± 0.00 | 0.13 ± 0.00 | 0.14 ± 0.00 | 0.12 ± 0.00 |
| C18:4n-3 | 0.10 ± 0.00 | 0.10 ± 0.00 | 0.09 ± 0.00 | 0.10 ± 0.00 | 0.08 ± 0.00 |
| C20:1n-9 | 0.20 ± 0.00 | 0.19 ± 0.00 | 0.17 ± 0.00 | 0.18 ± 0.00 | 0.14 ± 0.00 |
| C20:4n-6 | 0.14 ± 0.00 | 0.13 ± 0.00 | 0.12 ± 0.00 | 0.14 ± 0.00 | 0.12 ± 0.00 |
| C20:5n-3 | 0.72 ± 0.00 | 0.71 ± 0.01 | 0.65 ± 0.00 | 0.70 ± 0.00 | 0.57 ± 0.01 |
| C22:1n-11 | 0.14 ± 0.00 | 0.13 ± 0.00 | 0.11 ± 0.00 | 0.12 ± 0.00 | 0.08 ± 0.00 |
| C22:5n-3 | 0.14 ± 0.00 | 0.13 ± 0.00 | 0.12 ± 0.00 | 0.13 ± 0.00 | 0.10 ± 0.00 |
| C22:6n-3 | 1.45 ± 0.01 | 1.44 ± 0.01 | 1.33 ± 0.01 | 1.46 ± 0.01 | 1.21 ± 0.00 |

The contents are indicated in percentages by weight relative to the total weight of granules before drying.

1.3. Growth Performance Test

Triplicate groups of 35 rainbow trout (Oncorhynchus mykiss), with an initial body weight (IBW) of 5.01±0.1 g were fed with one of the five experimental diets for 90 days. The fish grew in circular glass-fibre tanks (volume: 250 L) supplied with a continuous flow of fresh water at temperatures comprised between 14.1±0.3° C. and levels of dissolved oxygen above 7.4 mg/L (see FIG. 1). The fish were subjected to summer conditions with natural photoperiod changes (May-July). The fish were hand-fed to apparent satiation, three times a day (9 h00, 14 h00 and 18 h00) during the week and twice a day at week-ends (10 h00 and 16 h00), taking the greatest care to avoid wasting the feed. The feed distributed was quantified throughout the length of the study. Anaesthetized fish were weighed individually at the start and at the end of the study and the group was weighed on day 28 and on day 60. At the start, 15 fish of the same initial stock were sampled and stored at −20° C. for subsequent analysis of the whole body composition. After 90 days of experimental feeding, 6 fish from each tank were sampled for the same purpose.

1.4. Apparent Digestibility Measurement

At the end of the growth test and following all the associated samplings, 12 fish (body weight: 45 g) from each replica tank were used to determine the apparent digestibility of the dry matter, proteins, lipids, energy and phosphorus, by the indirect method with identical diets containing yttrium oxide (200 mg/kg) as inert tracer. The fish were stored in cylindro-conical tanks (volume: 60 L; water flow rate: 3.7 L/min; levels of dissolved oxygen greater than 6.4 mg/L), at a constant water temperature of 14° C. The fish were adapted to the farming conditions and to the experimental diets over 10 days. Then, the fish were hand-fed once a day (10 h00), to slight excess. After deep cleaning of the rearing tanks to remove all the feed residues, the faecal matter was collected daily for the following 8 days using the continuous outlet water filtration system (Choubert-INRA system). After daily collection, the faecal matter was frozen at −20° C. The mixed faecal matter originating from each group of fish was lyophilized before analysis. Each diet was tested in triplicate.

The apparent digestibility coefficients (ADC) of the nutrients and of the feed energy in the experimental diets were calculated according to the formula:

$$A D C ( \% ) = 100 - [ \begin{matrix}\frac{\% concentration {Y}_{2} {O}_{3} feed}{\% concentration {Y}_{2} {O}_{3} faeces} \times \\ \frac{\% Energy or nutrients in faeces}{\% Energy or nutrients in feed}\end{matrix} ]$$

1.5. Analytical Methods

The test ingredients, the diets and the lyophilized faecal matter were ground before analysis. The whole-body samples were chopped, mixed, and a representative sample was lyophilized and homogenized with a laboratory mill before analysis. The analysis of the chemical composition of the ingredient, diets, faecal matter and whole fish was carried out using the following procedures: dry matter after drying at 105° C. for 24 h; ash by combustion at 550° C. for 12 h; crude protein (N×6.25) by a flash combustion technique followed by separation by gas chromatography and thermal conductivity detection (LECO FP428); the fat by extraction with dichloromethane (Soxhlet); the total phosphorus according to the ISO/DIS 6491 method using vanadomolybdic reagent; the crude energy in a adiabatic bomb calorimeter. The yttrium oxide in the feeds and the faeces was determined by the ICP-AES method.

For analyses of total amino acids, the test ingredients and the test diets were hydrolysed (6 M of HCL at 116° C. for 22 h in glass flasks rinsed with nitrogen), then derivatized with an AccQ (6-aminoquinolyl-N-hydroxysuccinimidyl) fluorine reagent according to the AccQ-Tag method (Waters, USA). The analyses were carried out by high performance liquid chromatography (HPLC) in a reverse-phase amino acid analysis system, using norvaline as internal standard. The tryptophan was not determined as it is partially destroyed by acid hydrolysis. The resulting peaks were analysed with EMPOWER software (Waters, USA). For the analysis of the fatty acids, the lipids were extracted according to the method of Folch et al. (1957) and subsequently, the fatty acid composition of the fillets was determined by analysis of the methyl esters by gas chromatography, according to the Lepage and Roy procedure (1986).

1.6. Criterion for Evaluating Growth and Use of the Nutrients

IBW (g): Initial body weight.

FBW (g): Final body weight.

Specific growth rate, SGR (%/day): (Ln FBW−Ln IBW)×100/days.

Feed conversion ratio, FCR: gross feed ration/weight gain.

Voluntary feed intake, VFI (% BW/day): (gross feed ration/(IBW+FBW)/2/days)×100.

Protein efficiency ratio PER: wet weight gain/crude protein intake.

Retention (% of intake): 100×(FBW×final nutrients content in the carcass−IBW×initial nutrients content in the carcass)/nutrient intake.

1.7. Statistical Analysis

The data are presented by the average of three repetitions ±the standard deviation. The data were subjected to one-factor analysis of variance. Before ANOVA, the values expressed in % were subjected to an arcsine square root transformation. The statistical significance was tested at a probability level of 0.05. All the statistical tests were carried out using IBM SPSS V21 software.

### 2. Results

2.1. Growth Performance

The data on the growth performances, feed conversion and protein efficiency of the rainbow trout fed with the experimental diets for 28, 60 and 90 days are reported in Tables 6-8 and FIG. 2. No deaths occurred during the test.

TABLE 6
Growth performances on day 28.

| Diet | CTRL | Y5 | Y7.5 | Y15 | Y25 |
|---|---|---|---|---|---|
| IBW | 5.0 ± | 4.9 ± 0.1 | 5.0 ± 0.1 | 5.1 ± 0.1 | 5.1 ± 0.1 |
| (g) | 0.1 | | | | |
| FBW | 16.1 ± | 16.2 ± 0.5 ^{a} | 16.2 ± 0.5 ^{a} | 17.9 ± 0.3 ^{b} | 17.6 ± 0.4 ^{b} |
| (g) | 0.1 ^{a} | | | | |
| SGR, | 4.19 ± | 4.26 ± 0.13 ^{a} | 4.20 ± 0.07 ^{a} | 4.50 ± 0.07 ^{b} | 4.45 ± 0.06 ^{b} |
| %/d | 0.12 ^{a} | | | | |
| FCR | 0.87 ± | 0.87 ± 0.02 ^{b} | 0.87 ± 0.03 ^{b} | 0.81 ± 0.00 ^{a} | 0.81 ± 0.01 ^{a} |
| | 0.01 ^{b} | | | | |
| Feed | 3.27 ± | 3.31 ± 0.09 | 3.28 ± 0.09 | 3.25 ± 0.03 | 3.22 ± 0.07 |
| intake, | 0.07 | | | | |
| % | | | | | |
| BWM/ | | | | | |
| d | | | | | |
| PER | 2.55 ± | 2.56 ± 0.05 ^{a} | 2.55 ± 0.08 ^{a} | 2.66 ± 0.01 ^{ab} | 2.72 ± 0.05 ^{b} |
| | 0.02 ^{a} | | | | |

The values are the averages ± the standard deviation (n = 3).
The values within a row with different exponents differ significantly (P < 0.05).

After 28 days of experimental feeding (Table 5), the fish have more than tripled their initial body weight. The feed intake was high (3.22-3.31% BWM/day) and was not affected (P>0.05) by the increasing doses of composition according to the invention incorporated. This observation suggests that the composition according to the invention had no negative effect on palatability, and even that it could compensate for the total elimination of fishmeal without compromising the feed intake. The growth rate varied from 4.19 to 4.50%/day. In comparison with the CTRL treatment, while the Y5 and Y7.5 diets did not affect the FBW and the SGR, the Y15 and Y25 diets led to a significant increase (P<0.05) in FBW and SGR. The values of the feed conversion ratio vary between 0.81 and 0.87. In comparison with the CTRL, the inclusion of composition according to the invention at 5 and 7.5% (Y5 and Y7.5% diets) did not affect the FCR. However, the high levels of inclusion of composition according to the invention (Y15 and Y25 diets) led to a significant reduction in FCR (P<0.05). The protein efficiency ratio (PER) varied between 2.55 and 2.72. The fish fed with a Y25 diet showed a significant increase in PER, compared with those fed with the CTRL, Y5 and Y7.5 diets.

TABLE 7
Growth performances on day 60.

| Diet | CTRL | Y5 | Y7.5 | Y15 | Y25 |
|---|---|---|---|---|---|
| IBW | 5.0 ± | 4.9 ± 0.1 | 5.0 ± 0.1 | 5.1 ± 0.1 | 5.1 ± 0.1 |
| (g) | 0.1 | | | | |
| FBW | 30.3 ± | 31.6 ± 0.5 ^{a} | 34.9 ± 1.5 ^{b} | 37.2 ± 0.9 ^{c} | 42.9 ± 0.4 ^{d} |
| (g) | 0.1 ^{a} | | | | |
| SGR, | 3.00 ± | 3.10 ± 0.04 ^{b} | 3.24 ± 0.04 ^{c} | 3.31 ± 0.05 ^{c} | 3.57 ± 0.04 ^{d} |
| %/d | 0.04 ^{a} | | | | |
| FCR | 1.10 ± | 1.02 ± 0.03 ^{c} | 0.92 ± 0.01 ^{b} | 0.90 ± 0.02 ^{b} | 0.85 ± 0.02 ^{a} |
| | 0.03 ^{d} | | | | |
| PER | 2.01 ± | 2.17 ± 0.06 ^{b} | 2.40 ± 0.02 ^{c} | 2.46 ± 0.06 ^{cd} | 2.56 ± 0.07 ^{d} |
| | 0.06 ^{a} | | | | |

The values are the averages ± the standard deviation (n = 3).
The values within a row with different exponents differ significantly (P < 0.05).

After 60 days of experimental feeding (Table 6), the fish undergoing the most effective treatment showed an increase of 8 times the initial body weight. The growth rate varied from 3.00 to 3.57%/day. In comparison with the CTRL treatment, all the diets with the composition according to the invention showed a significant increase (P<0.05) in SGR. The FCR values varied between 0.85 and 1.10 and in comparison with the CTRL, the inclusion of the composition according to the invention at all the doses tested led to a significant reduction in FCR (P<0.05). The protein efficiency ratio (PER) varied between 2.01 and 2.56. The lowest PER value was found in the fish fed with a CTRL diet, while an improvement in PER was closely associated with increasing doses of the composition according to the invention.

TABLE 8
Growth performances on day 90.

| Diet | CTRL | Y5 | Y7.5 | Y15 | Y25 |
|---|---|---|---|---|---|
| IBW | 5.0 ± | 4.9 ± 0.1 | 5.0 ± 0.1 | 5.1 ± 0.1 | 5.1 ± 0.1 |
| (g) | 0.1 | | | | |
| FBW | 42.9 ± | 45.2 ± 1.0 ^{b} | 49.0 ± 0.6 ^{c} | 51.0 ± 1.4 ^{c} | 55.9 ± 1.0 ^{d} |
| (g) | 1.3 ^{a} | | | | |
| SGR, | 2.39 ± | 2.47 ± 0.02 ^{b} | 2.54 ± 0.03 ^{b} | 2.56 ± 0.05 ^{b} | 2.67 ± 0.04 ^{c} |
| %/d | 0.06 ^{a} | | | | |
| FCR | 0.93 ± | 0.83 ± 0.03 ^{a} | 0.80 ± 0.02 ^{a} | 0.79 ± 0.04 ^{a} | 0.79 ± 0.02 ^{a} |
| | 0.02 ^{b} | | | | |
| PER | 2.38 ± | 2.68 ± 0.10 ^{b} | 2.76 ± 0.06 ^{b} | 2.80 ± 0.15 ^{b} | 2.74 ± 0.08 ^{b} |
| | 0.06 ^{a} | | | | |

The values are the averages ± the standard deviation (n = 3).
The values within a row with different exponents differ significantly (P < 0.05).

At the end of the test, 90 days of experimental feeding (Table 8), the fish undergoing the most effective treatment showed an increase of 11 times the initial body weight. In comparison with the CTRL fish, those fed with the diets rich in insects showed a significant increase in final body weight (P<0.05). This increase was dose-related, with a moderate increase for the Y5 diet, intermediate for Y7.5 and Y15, and highest for Y25. The specific growth rate (SGR) varied between 2.39 and 2.67%/day, with a minimal value found in the fish fed with a CTRL diet, while those fed with feeds containing the composition according to the invention showed significantly higher SGR values (p<0.05). Independently of the level of incorporation, the composition according to the invention led to a significant reduction in FCR (P<0.05). In comparison with the CTRL treatment, all the diets comprising meals of insects led to a significant increase in the PER values (P<0.05).

2.2. Composition of the Whole Body

The data on the composition of the whole body of the trout at the end of the test are presented in Table 9. The feeding treatments had no effect (P>0.05) on the moisture, protein, lipid, ash, phosphorus and energy levels of the whole fish.

TABLE 9
Composition of the whole body of the trout fed with the
various feed treatments.

| Body | | | | | |
|---|---|---|---|---|---|
| com- | | | | | |
| position | CTRL | Y5 | Y7.5 | Y15 | Y25 |
| Moisture, | 70.1 ± 0.6 | 70.7 ± 0.4 | 71.1 ± 0.4 | 70.5 ± 0.5 | 70.7 ± 1.2 |
| % | | | | | |
| Protein, | 14.8 ± 0.6 | 14.8 ± 0.3 | 15.0 ± 0.5 | 15.2 ± 0.3 | 15.2 ± 0.7 |
| % | | | | | |
| Fat, % | 12.2 ± 0.2 | 11.5 ± 0.4 | 11.0 ± 0.3 | 11.6 ± 0.1 | 11.8 ± 0.9 |
| Ash, % | 1.9 ± 0.0 | 2.2 ± 0.2 | 2.1 ± 0.3 | 2.1 ± 0.0 | 2.2 ± 0.1 |
| Phos- | 0.4 ± 0.0 | 0.4 ± 0.0 | 0.4 ± 0.0 | 0.4 ± 0.0 | 0.4 ± 0.0 |
| phorus, | | | | | |
| % | | | | | |
| Energy, | 8.2 ± 0.1 | 8.0 ± 0.0 | 8.0 ± 0.0 | 8.0 ± 0.2 | 8.2 ± 0.4 |
| kJ/g | | | | | |

The percentages are percentages by weight relative to the total weight of the fish.
The values are the averages ± the standard deviation (n = 3).
Initial fish: moisture 75.0%; protein 14.1%; fats 8.7%; ash 2.2%; phosphorus 0.4%, energy 6.7 kJ/g.

2.3. Nutrient Retention

The nutrient and energy retention values (expressed in percentage of intake) are presented in Table 10. In comparison with the CTRL treatment, the fish fed with diets rich in the composition according to the invention showed a significant increase in protein and energy retention (P<0.05). Similarly, the Y7.5, Y15 and Y25 diets showed a P retention significantly higher than the CTRL (P<0.05). Fat retention was not affected by the diets (P>0.05).

TABLE 10
Nutrient and energy retention in the trout fed with the various diets.

| Reten- | | | | | |
|---|---|---|---|---|---|
| tion, % | | | | | |
| intake | CTRL | Y5 | Y7.5 | Y15 | Y25 |
| Protein | 35.5 ± 2.5 ^{a} | 39.8 ± 0.7 ^{b} | 41.6 ± 0.4 ^{b} | 42.8 ± 2.2 ^{b} | 41.9 ± 2.2 ^{b} |
| Fat | 64.4 ± 2.1 | 68.0 ± 4.9 | 66.8 ± 3.3 | 71.5 ± 3.4 | 70.9 ± 6.7 |
| Phos- | 30.5 ± 0.7 ^{a} | 32.7 ± 1.8 ^{ab} | 34.0 ± 0.7 ^{b} | 33.9 ± 1.7 ^{b} | 33.8 ± 1.1 ^{b} |
| phorus | | | | | |
| Energy | 42.0 ± 0.8 ^{a} | 45.4 ± 1.6 ^{b} | 47.1 ± 1.4 ^{b} | 47.8 ± 1.8 ^{b} | 48.0 ± 2.9 ^{b} |

The values are the averages ± the standard deviation (n = 3).
The values within a row with different exponents differ significantly (P < 0.05).

2.4. Apparent Digestibility

The composition of the faecal matter collected from the trout fed with the various feed treatments is presented in Table 11.

TABLE 11
Composition of the faecal matter of the trout fed with the various
diets.

| Compo- | | | | | |
|---|---|---|---|---|---|
| sition of | | | | | |
| faecal | | | | | |
| matter | CTRL | Y5 | Y7.5 | Y15 | Y25 |
| Yttrium | 1384 ± | 1395 ± 94 | 1415 ± 61 | 1369 ± 62 | 1411 ± |
| oxide, | 39 | | | | 43 |
| (mg/kg) | | | | | |
| Protein, | 19.63 ± | 19.67 ± 0.24 | 19.76 ± 0.34 | 19.70 ± 0.38 | 19.20 ± |
| % DM* | 0.06 | | | | 0.41 |
| Fats, % | 4.37 ± | 4.33 ± 0.19 | 4.28 ± 0.24 | 4.30 ± 0.06 | 4.20 ± |
| DM* | 0.06 | | | | 0.33 |
| Phos- | 2.64 ± | 2.77 ± 0.08 | 2.65 ± 0.10 | 2.54 ± 0.15 | 2.62 ± |
| phorus, | 0.06 | | | | 0.09 |
| % | | | | | |
| DM* | | | | | |
| Energy, | 23.24 ± | 23.14 ± 0.40 | 23.47 ± 0.47 | 22.88 ± 0.16 | 23.09 ± |
| kJ/g DM | 0.16 | | | | 0.16 |

*Percentage by weight relative to the total weight of dry faecal matter.
The values are the averages ± the standard deviation (n = 3).

The apparent digestibility coefficients (ADC %) for the different nutrients and energy are presented in Table 12. The increase in the doses of composition according to the invention incorporated had no significant effect (P>0.05) on the apparent digestibility of the dry matter, proteins, fat, phosphorus and energy.

TABLE 12
Apparent digestibility of the nutrients and energy in the trout.

| ADC % | CTRL | Y5 | Y7.5 | Y15 | Y25 |
|---|---|---|---|---|---|
| Dry matter | 84.2 ± 0.4 | 84.2 ± 1.0 | 84.3 ± 0.7 | 84.0 ± 0.7 | 84.3 ± 0.5 |
| Protein | 93.6 ± 0.2 | 93.6 ± 0.4 | 93.6 ± 0.2 | 93.5 ± 0.4 | 93.8 ± 0.1 |
| Fat | 97.0 ± 0.1 | 97.0 ± 0.1 | 97.0 ± 0.2 | 97.0 ± 0.2 | 97.1 ± 0.3 |
| Phosphorus, | 69.9 ± 1.4 | 68.3 ± 1.5 | 70.5 ± 2.4 | 71.4 ± 2.9 | 70.3 ± 1.8 |
| % of intake | | | | | |
| Energy, % | 84.1 ± 0.4 | 84.3 ± 0.8 | 84.1 ± 1.0 | 84.2 ± 0.6 | 84.4 ± 0.6 |
| of intake | | | | | |

The values are the averages ± the standard deviation (n = 3).

### 3. Conclusion

At the end of 90 days of experimental feeding, the overall growth performance can be considered as very satisfactory and in a higher range for the young rainbow trout, with SGR values for the total duration of the test varying between 2.4 and 2.7%/day. In the most effective treatments, the fish showed an increase of 11 times their initial body weight. The feed conversion rate among the treatments varied between 0.79 and 0.93, which suggests a good nutritional adequacy of the feeds and good feeding practices.

The experimental data generated in this example make it possible to affirm that:
The incorporation of increasing doses of composition according to the invention (5, 7.5, 15 and 25%) with a concomitant reduction in fishmeal was progressively linked to a significant increase in the body weight of the fish.
All the diets containing the composition according to the invention showed a significant improvement in SGR, FCR and PER.
The increasing doses of composition according to the invention incorporated had no effect on the composition of the whole body of the trout.
The increasing doses of composition according to the invention incorporated had no effect on the apparent digestibility of the dry matter, proteins, lipids, phosphorus and energy in the different experimental diets.
The proteins, the phosphorus and energy retention were enhanced in trout fed with feeds comprising the composition according to the invention.

In general, the composition according to the invention utilized in this example could effectively replace 100% of the fishmeal in the diet of juvenile rainbow trout with positive effects on FCR and overall growth performance.

### EXAMPLE 5: METHODS WITH OR WITHOUT GRINDING PRIOR TO PRESSING

Method with Pressing Only

200 g of T. molitor larvae are introduced into a beaker, placed in a water bath at 100° C. and containing 200 mL of water brought to the boil beforehand. After 5 minutes, the beaker is removed from the water bath, the larvae are drained, then passed into a twin-screw-type press. A press cake is thus obtained.

Method with Grinding Followed by Pressing

200 g of T. molitor larvae are introduced into a beaker, placed in a water bath at 100° C. and containing 200 mL of water brought to the boil beforehand. After 5 minutes, the beaker is removed from the water bath, the larvae are drained, then mixed with a volume of water of 200 mL. The liquid thus obtained is passed into a twin-screw-type press. A press cake is thus obtained.

Measurement of the Lipid Content

2 g of sample is placed in a beaker to which 0.2 g of Na₂SO₄ and 15 mL of CHCl₃/MeOH (2/1 v/v) are added. The mixture is placed under magnetic stirring for 20 minutes, then the solution is filtered, the residue is again placed in the beaker with 10 mL of CHCl₃/MeOH (2/1 v/v). The mixture is placed under magnetic stirring for 15 minutes, then the solution is filtered, the solvent phases are combined and evaporated to constant weight. The lipid content is determined as a percentage by weight after extraction-evaporation relative to the initial weight of the sample (2 g).

Conclusion

The significance of grinding upstream of pressing was studied (FIG. 3). It is thus clearly apparent that the distribution of the lipids between the press cake and the press juice is much more effective, 12.9 versus 87.1 as opposed to 42.7 versus 57.3, when grinding was carried out beforehand.

### EXAMPLE 6: ANALYSIS OF THE SIZE OF THE SOLUBLE PROTEINS OF THE COMPOSITION ACCORDING TO THE INVENTION

A sample of 100 mg of the composition prepared in Example 1 was placed in 10 mL of NaCl phosphate buffer (pH 7.4, 0.137 mM). The sample was stirred for 1 minute (vortex), then centrifuged at 900 g for 1 min. After centrifugation, the sample was filtered through a 0.45 μm membrane. Analysis of the size of the soluble proteins was carried out using a steric exclusion chromatography system with a Nucleogel GFC-300 column. An NaCl phosphate buffer (pH 7.4, 0.137 mM) was used as eluent. The flow rate was 1.0 mL/min. Detection was carried out with a UV detector at 280 nm.

The results of the analysis are presented in FIG. 4 and summarized in Table 13 below.

TABLE 13
Distribution of the sizes of the soluble proteins contained in the
composition prepared in Example 1

| Size of the proteins (kg/mol) | Relative abundance (%) |
|---|---|
| 6.5 to 12.4 | 74.4 |
| 12.4 to 29 | 20.5 |
| 29 to 66 | 5.1 |

The results show that approximately 74.4% of the soluble proteins present in the composition according to the invention have a molar mass of less than 12,400 g/mol (or Da, Daltons).

1. Composition comprising at least 67% by weight crude proteins, at least 5% by weight chitin, the percentages by weight being given relative to the total weight of composition, and 85% by weight digestible proteins relative to the total weight of crude proteins.

2. Composition according to claim 1, comprising ash in a content less than or equal to 4% by weight relative to the total weight of composition.

3. Composition according to claim 1 or 2, comprising fat in a content comprised between 5 and 20% by weight relative to the total weight of composition.

4. Composition according to any one of claims 1 to 3, obtained from insects.

5. Composition according to any one of claims 1 to 4, the residual moisture content of which is comprised between 2 and 15%.

6. Composition according to any one of claims 1 to 5, comprising between 30 and 60% by weight soluble proteins relative to the total weight of crude proteins, in which at least 50% of the soluble proteins have a size less than or equal to 12,400 g/mol.

7. Method for the preparation of a composition according to any one of claims 4 to 6, comprising the following steps:
i) killing the insects,
ii) pressing the insects in order to obtain a press cake, and
iii) grinding the press cake.

8. Method according to claim 7, also comprising a step of drying the press cake.

9. Method according to claim 8, comprising the following steps:
i) killing the insects,
ii) pressing the insects in order to obtain a press cake,
iii) drying the press cake, and
iv) grinding the press cake,
in which the pressing step is preceded by a step of grinding the insects.

10. Method according to claim 8, comprising the following steps:
i) killing the insects,
ii) pressing the insects in order to obtain a press cake,
iii) drying the press cake, and
iv) grinding the press cake,
in which the pressing step is carried out hot.

11. Method according to claim 8, comprising the following steps:
i) killing the insects,
ii) pressing the insects in order to obtain a press cake,
iii) drying the press cake, and
iv) grinding the press cake,
in which the step of grinding the press cake is carried out to a particle size comprised between 300 μm and 1 mm.

12. Use of the composition according to any one of claims 1 to 6, in human or animal nutrition.

13. Use according to claim 12, in which the composition is used to replace protein flour.
